(19) United States
(12) Patent Application Publication
(10) Pub. No.: US 2007/0276624 A1
(43) Pub. Date: Nov. 29, 2007

(54) METHOD FOR IMPROVING TEST SUGGESTION REPORT ON ELECTRONIC PARTS

(75) Inventors: Hung-Sheng Wang, Taipei (TW); Chi-Yen Ho, Taipei (TW); Din-Guow Ma, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Corporation, Taipei (TW)

(21) Appl. No.: 11/420,659

(22) Filed: May 26, 2006

(51) Int. Cl. G06F 19/00

(52) U.S. Cl. 702/123; 702/108; 702/117

(57) ABSTRACT

A method for improving a test suggestion report on electronic parts is provided, which includes providing a test database in which the model data, test type data, and magnitude data of the weight value of test points are stored; providing a circuit board; providing a data table of the electronic parts of the circuit board, wherein the test data table of the electronic parts provides data of a plurality of electronic parts in accordance with the circuit board; providing a suggestion report, wherein the test points and data of the weight values thereof based on the data of the plurality of electronic parts are acquired by comparing the data table with the test database, so as to upgrade the test coverage rate for the electronic parts and avoid affecting the test efficiency by the addition of a large number of test points of electronic parts.

### BACKGROUND OF THE INVENTION

1. Field of Invention

The present invention relates to a method for improving a test suggestion report on electronic parts, and more particularly to a method for providing information on the weight value of test points so as to improve the test suggestion report on electronic parts.

2. Related Art

Currently when composing test programs of test fixtures for electronic parts, test engineers will additionally provide the designers or wiring staff with a suggestion report directed to the requirements of test points on a circuit board or a motherboard. The suggestion report is used as a reference when the circuit board or motherboard is redesigned, so as to obtain a higher test coverage rate for the electronic parts on the circuit board or motherboard.

However, a conventional suggestion report on the requirements of test points provided by test engineers of electronic parts lists all test points and is delivered to the designers or wiring staff to determine whether the test points are to be placed on the circuit board or motherboard or not. However, the existing suggestion report on test points does not present the weight value of each test point, and so of course cannot assist the designers or wiring staff in evaluating the magnitude of the weight value of each test point; therefore, the designers or wiring staff are unable to decide which test points should be added. Thus, failure to improve the test coverage rate for the electronic parts may result, even if a large number of test points are added by the designers or wiring staff, and test efficiency is unable to be improved due to the addition of a large number of test points. Moreover, as current designs of electronic parts on the circuit board or motherboard tend to be more and more intensive, the arrangement and distribution of test points becomes more and more difficult on a limited and ever-decreasing board surface space.

Therefore, the conventional suggestion report on the requirements of the test points on the circuit board or motherboard has the disadvantage that the weight value of each test point is unable to be presented, so it is an object for the researchers to research and develop a method for improving the test suggestion report on electronic parts, i.e., it is a method for providing information on the weight value of test points for testing the coverage rate.

### SUMMARY OF THE INVENTION

According to one aspect of the invention, a method for improving the test suggestion report on electronic parts is provided. The method includes the steps of: providing a test database, wherein the model data of the electronic parts, test type data of the electronic parts, and magnitude data of the weight value of test points are stored; providing a circuit board with a plurality of electronic parts; providing a data table of the electronic parts on the circuit board for providing data of the plurality of electronic parts in accordance with the circuit board; providing a suggestion report, wherein test points and data of the weight values thereof based on the data of the plurality of electronic parts are acquired by comparing the data table of the electronic parts with the test database, so as to enhance the test coverage rate for the above circuit board.

Accordingly, it is an object of the present invention to provide a method for improving the test suggestion report on electronic parts to upgrade the test coverage rate for the electronic parts by adding the test points to the redesigned circuit board or motherboard according to the magnitude of the weight value of the test points.

Another object of the present invention is to provide a method for improving the test suggestion report on electronic parts to avoid the test efficiency being unable to be improved and the area of the board surface of the circuit board or motherboard being over-crowded due to the addition of a great number of test points of electronic parts when redesigning the circuit board or motherboard.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a test database of the present invention; and

FIG. 2 is a flow chart of a method for improving the test suggestion report on electronic parts according to the invention.

### DETAILED DESCRIPTION OF THE INVENTION

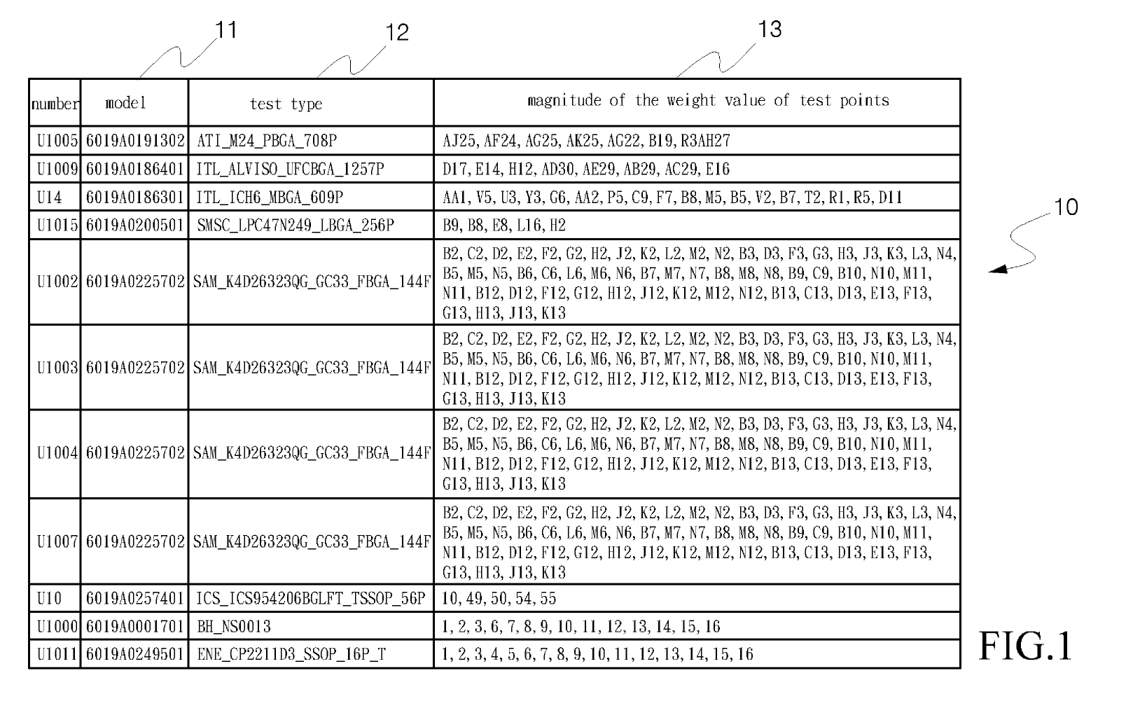

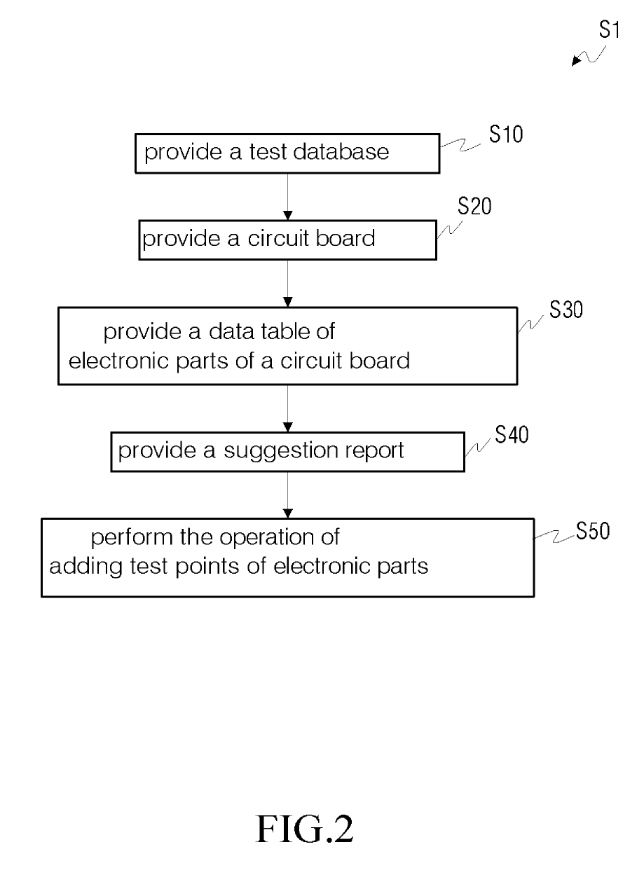

As shown in FIGS. 1 and 2, they are a schematic view of a test database and a flow chart of a method for improving the test suggestion report on electronic parts according to the invention. The invention provides a method S1 for improving the test suggestion report on electronic parts, including: first, providing a test database 10 (step S10) with model data 11 of the electronic parts, test type data 12 of the electronic parts, and magnitude data 13 of the weight value of the test points are stored therein, wherein the magnitude data 13 of the weight value of the test points are marked by different colors to help distinguish the magnitude data of the weight value of each test point; next, providing a circuit board (step S20) with a plurality of electronic parts; and then, providing a data table of the electronic parts on the circuit board (step S30), wherein the data table of the electronic parts provides data of the electronic parts on the assembled circuit board, and more particularly, the data of the plurality of electronic parts include the model data 11 of the electronic parts on the circuit board so as to perform the following comparison between the data table of the electronic parts with the test database 10 of the electronic parts; after that, providing a suggestion report (step S40), wherein the test points and data of the weight value thereof based on the data of the plurality of electronic parts in the data table of the electronic parts are acquired by comparing the data table of the electronic parts with the test database 10 of the electronic parts; finally, performing the operation of adding test points of the electronic parts (step S50), that is, preferentially adding the test points of a high weight value to the circuit board in accordance with the magnitude data 13 of the weight value of the test points, so as to enhance the test coverage rate for the circuit board and solve the problem of adding excessive test points at a time, thereby avoiding the arrangement and distribution of the test points of the electronic parts becoming more difficult on a limited and ever-decreasing circuit board space.

The present invention provides a method S1 for improving the test suggestion report on electronic parts by which the test coverage rate for the electronic parts is improved, wherein the test database 10 is a relational database, and moreover, the above circuit board is a flexible circuit board or a rigid circuit board.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for improving a test suggestion report on electronic parts, comprising:
providing a test database, wherein model data of electronic parts and magnitude data of a weight value of test points are stored;
providing a circuit board with a plurality of electronic parts;
providing a data table of the plurality of electronic parts of the circuit board, wherein the data table of the plurality of electronic parts provides data on the plurality of electronic parts in accordance with the circuit board; and
providing a suggestion report, wherein the test points and magnitude data of the weight value of the test points based on the data on the plurality of electronic parts in the data table of the plurality of electronic parts are acquired by comparing the data table of the plurality of electronic parts with the test database.

2. The method for improving the test suggestion report on electronic parts as claimed in claim 1, wherein the method further comprises the operation of adding the test points of electronic parts according to the magnitude data of the weight value of test points of data for the electronic parts provided by the suggestion report.

3. The method for improving the test suggestion report on electronic parts as claimed in claim 1, wherein the test database is a relational database.

4. The method for improving the test suggestion report on electronic parts as claimed in claim 1, wherein the circuit board is a flexible circuit board.

5. The method for improving the test suggestion report on electronic parts as claimed in claim 1, wherein the circuit board is a rigid circuit board.
